(19) United States
(12) Patent Application Publication
(10) Pub. No.: US 2015/0321149 A1
(43) Pub. Date: Nov. 12, 2015

(54) SELECTIVE MEMBRANES FORMED BY ALIGNMENT OF POROUS MATERIALS

(71) Applicant: Robert MCGINNIS, Coventry, CT (US)

(72) Inventor: Robert MCGINNIS, Coventry, CT (US)

(21) Appl. No.: 14/651,877

(22) PCT Filed: Dec. 19, 2013
(86) PCT No.: PCT/US2013/076559

§ 371 Date: Jun. 12, 2015

Related U.S. Application Data
(60) Provisional application No. 61/739,699, filed on Dec. 19, 2012.

(51) Int. Cl. B01D 67/00; B29C 65/00; B29C 67/24; B01D 69/12; B29C 67/00

(52) U.S. Cl. CPC B01D 67/0002; B01D 69/125; B01D 67/009; B29C 67/0011; B29C 67/24; B29C 66/40; B01D 2323/345; B01D 2323/35; B29K 2029/04

(57) ABSTRACT

Embodiment methods for creating a selective membrane using at least one anisotropic porous material are provided. Following fabrication and selection of high aspect ratio porous structures, creating the selective membrane includes aligning the at least one anisotropic porous material in an aligned position by introducing a first signal input, and fixing the at least one anisotropic porous material in the aligned position by introducing a second signal input. In some embodiment methods, the at least one anisotropic porous material is one or more of carbon nanotubes, aquaporin, and synthetic aquaporin pore structures.

### RELATED APPLICATIONS

This patent application claims the benefit of priority to U.S. Provisional Patent Application Ser. No. 61/739,699, entitled “Selective Membranes by Alignment of Porous Materials” filed on Dec. 19, 2012, the entire contents of which are hereby incorporated by reference.

### FIELD OF THE INVENTION

The present invention relates generally to the use of porous materials to form selective membranes, and more particularly to the alignment and fixation of porous anisotropic porous materials by optical, chemical or electrical signals.

### BACKGROUND

The use of porous membranes to separate dissolved aqueous or gaseous substances has been limited. For aqueous suspensions, porous membranes have been capable of only limited selectivity for particular solutes, such as small molecular weight organics or ionic compounds such as salt. Similarly, gas separations using porous materials have been limited to the separation of relatively large molecules. Separations requiring selectivity for small dissolved aqueous, or small gaseous substances, therefore, largely employ non-porous mechanisms for selectivity, such as polyamide membranes for aqueous separations, or rubber or silicone membranes for gas separations. These mechanisms are typically described by solution-diffusion models of species permeation through dense polymer films. However, solution-diffusion separations often involve selectivity/permeability tradeoffs. For example, polyamide membranes are only useable in pHs in the range of about 2-11, and have highly variable rejection characteristics for many solutes. Small, uncharged molecules readily permeate such membranes, for example, and complex co-transport and counter transport ion effects may occur, particularly in osmotically driven membrane processes such as forward osmosis.

Certain porous materials, such as aquaporin and small aperture carbon nanotubes, may provide extremely high selectivity and permeability. Several of these porous materials, such as carbon nanotubes, may additionally be manufactured with a wide variety of inner diameters, which could allow their use for tunable and highly specific gas and liquid separations. The ability to inexpensively and effectively align and fix porous structures with pore sizes<10 Angstrom (Å) range with high aspect ratios, small mean pore size distributions, and high permeability rates within thin films may improve various aqueous and gaseous separation processes, such as those requiring transport of small polar substances.

### SUMMARY

The various embodiments provide methods of forming a selective porous membrane from at least one anisotropic porous material, including aligning the at least one anisotropic porous material in an aligned position by introducing a first signal input, and fixing the at least one anisotropic porous material in the aligned position by introducing a second signal input. In some embodiment methods the at least one anisotropic porous material is one or more of carbon nanotubes, aquaporin, and synthetic aquaporin pore structures.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is an illustration representing an example photo-responsive trans azobenzene group.

FIG. 1B is a schematic illustration representing an example photo-responsive trans stilbene group.

FIG. 2A-2C are schematic illustrations representing an example structure formed during an embodiment process of forming a selective membrane using nanotubes.

FIG. 2D is a schematic illustration representing an example structure in which nanotubes and liquid crystals are perpendicular to a surface based on a trans conformation of an attached azobenzene group.

FIG. 2E is a schematic illustration representing an example structure in which nanotubes and liquid crystals are parallel to a surface based on a cis conformation of an attached azobenzene group.

FIGS. 3A and 3B are schematic illustrations representing example structures of another embodiment, respectively before and after the alignment of the nanotubes.

FIGS. 4A-4C are schematic illustrations representing example structures in another embodiment, respectively before fixation, after fixation, and during post-processing.

FIGS. 5A-5B are schematic illustrations representing steps in an embodiment process of forming a selective membrane using nanotubes and a porous second material.

FIGS. 5C-5I are schematic illustrations representing steps in an embodiment process of forming a selective membrane using a continuous process.

### DETAILED DESCRIPTION

The term “membrane separation process” is used to refer to processes that separate gaseous or liquid streams through a semi-permeable non-porous or porous barrier in a membrane separation system.

As used herein, the terms “signal responsive,” “photo-reactive,” “electroreactive,” and “thermoreactive” refer generally to materials in which measurable changes occur in response to energy input. Many such designations depicting the input and its measurable effects may be used, which may be referred generally to an “input-effect.”

The terms “porous material” and “porous structure” are interchangeably herein to refer generally to permeable organic and/or inorganic materials.

As used herein, the term “nanotube” refers generally to a cylindrical tubular structure that have pores or channels on a nanometer scale, such as less than 5 nm (e.g., between 0.4 and 0.5 nm). Nanotubes of a variety of materials may be used, such as carbon nanotubes and boron nitride nanotubes. Those that have been most extensively studied are carbon nanotubes, whose features and methods of fabrication are illustrative of nanotubes in general.

The terms “carbon nanotubes” and “CNTs” are used interchangeably herein to refer generally to cylindrical structures of pure carbon, and exist as single-wall and multiwall structures. Examples of publications describing carbon nanotubes and their methods of fabrication are Dresselhaus, M. S., et al., Science of Fullerenes and Carbon Nanotubes, 20 Academic Press, San Diego (1996), Ajayan, P. M., et al., “Nanometre-Size Tubes of Carbon,” Rep. Prog. Phys. 60 (1997): 1025-1062, and Peigney, A., et al., “Carbon nanotubes in novel ceramic matrix nanocomposites,” Ceram. Inter. 26 (2000) 677-683. A single-wall carbon nanotube is a single graphene sheet rolled into a seamless cylinder with either open or closed ends. When closed, the ends are capped either by halffullerenes or by more complex structures such as pentagonal lattices. The average diameter of a single-wall carbon nanotube typically ranges of 0.6 nm to 100 nm, and in many cases 1.5 nm to 10 nm, with an internal diameter of about 0.04 to 0.05 nm. The aspect ratio, i.e., length to diameter, typically ranges from about 25 to about 1,000,000, and most often from about 100 to about 1,000. A nanotube of 1 nm diameter may thus have a length of from about 100 to about 1,000 nm. Nanotubes frequently exist as “ropes,” which are bundles of 3 to 500 single-wall nanotubes held together along their lengths by van der Waals forces. Individual nanotubes often branch off from a rope to join nanotubes of other ropes. Multi-walled carbon nanotubes are two or more concentric cylinders of graphene sheets of successively larger diameter, forming a layered composite tube bonded together by van der Waals forces, with a distance of 5 approximately 0.34 nm between layers. Carbon nanotubes can be prepared by arc discharge between carbon electrodes in an inert gas atmosphere. This process results in a mixture of single-wall and multi-wall nanotubes, although the formation of single-wall nanotubes can be favored by the use of transition metal catalysts such as iron or cobalt.

Single-wall nanotubes can also be prepared by laser ablation, as disclosed by Thess, A., et al., “Crystalline Ropes of Metallic Carbon Nanotubes,” Science 273 (1996): 483-487, and by Witanachi, S., et al., “Role of Temporal Delay in Dual-Laser Ablated Plumes,” J Vac. Sci. Technol. A 3 (1995): 1171-1174. A further method of producing singlewall nanotubes is the high-pressure carbon monoxide conversion (“HiPCO”) process disclosed by Nikolaev, P., et al., “Gas-phase catalytic growth of single-walled carbon nanotubes from carbon monoxide,” Chem. Phys. Lett. 313, 91-97 (1999), and by Bronikowski, M.]., et al., “Gas phase production of carbon single-walled nanotubes from carbon monoxide via the HiPCO process: A parametric study,” J Vac. Sci. Technol. 19, 1800-1805 (2001).

The various embodiments provide for alignment and fixation of porous materials to form selective membranes for liquid and gas separation processes. In some embodiments, alignment of the porous materials may be in a suspension, and may be performed by introduction of a signal to the suspension. In some embodiments, signal inputs may induce the alignment of porous materials in a process that occurs after fabrication of the porous materials. In this manner, a wide variety of porous material manufacturing methods may be used, with high degrees of control over the properties and uniformity of the porous materials, such as mean pore diameter, mean pore size distribution, porous material chemistry, and total porosity of the surface. Porous films formed by these processes may have both high selectivity and permeability characteristics. Other benefits may include chemical resistance, such as from bleach or other chemicals used in membrane cleaning, as well as operation in larger ranges of pH, redox potential, and temperatures.

In various embodiments, the porous materials may be porous structures, such as carbon nanotubes or aquaporin, with hydrophobic pore interior for the transport of polar substances (e.g., fluids) such as water.

In particular, the alignment of porous structures is made possible by several methods, including the use of organic molecules that may be attached to porous structures by various means, and that contain functional groups or other moieties that cause a change in conformation of the molecules upon receipt of a signal, the use of shear forces, and/or field gradients. The aligned porous structures may then be fixed in place by various methods. Such fixation methods may include, for example, cross-linking, polymerization, or other reactions between portions of aligning organic molecules and/or other materials within which they are mixed, and/or reactions among species of the suspension around the porous structures and associated molecules that cause them to solidify to entrap the porous structures in an aligned state in a solid material and/or on a surface of a substrate.

Examples of porous materials that may be used in the various embodiments include structures such as carbon nanotubes (CNTs), aquaporin, and non-CNT synthetic porous tubes (e.g., boron nitride nanotubes). Carbon nanotubes can be prepared by arc discharge between carbon electrodes in an inert gas atmosphere. This process results in a mixture of single-wall and multi-wall nanotubes, although the formation of single-wall nanotubes can be favored by the use of transition metal catalysts such as iron or cobalt. Single-wall nanotubes can also be prepared by laser ablation, as 10 disclosed by Thess, A., et al., “Crystalline Ropes of Metallic Carbon Nanotubes,” Science 273 (1996): 483-487, and by Witanachi, S., et al., “Role of Temporal Delay in Dual-Laser Ablated Plumes,” J Vac. Sci. Technol. A 3 (1995): 1171-1174. A further method of producing singlewall nanotubes is the high-pressure carbon monoxide conversion (“HiPCO”) process disclosed by Nikolaev, P., et. al., “Gas-phase catalytic growth of single-walled carbon nanotubes from 15 carbon monoxide,” Chem. Phys. Lett. 313, 91-97 (1999), and by Bronikowski, M.]., et al., “Gas phase production of carbon single-walled nanotubes from carbon monoxide via the HiPCO process: A parametric study,” J Vac. Sci. Technol. 19, 1800-1805 (2001). Certain procedures for the synthesis of nanotubes will produce nanotubes with open ends while others will produce closed-end nanotubes. If the nanotubes are synthesized in closed-end form, the closed ends can be opened by a variety of methods known in the art. An example of a nanotube synthesis procedure that produces open-ended nanotubes is that described by Hua, D. H. (Kansas State University Research Foundation), Intl. Published Patent Application No. WO 2008/048227 A2, published Apr. 24, 2008. Closed ends may be opened by mechanical means such as cutting, by chemical means or by thermal means. An example of a cutting method is milling Chemical means include the use of carbon nanotube degrading agents, an example of which is a mixture of a nitric acid and sulfuric acid in aqueous suspension at concentrations of up to 70% and 96%, respectively Another chemical means is reactive ion etching. Thermal means include exposure to elevated temperature in an oxidizing atmosphere. The oxidizing atmosphere can be achieved by an oxygen concentration ranging from 20% to 100% by volume, and the temperature can range from 200° C. to 450° C.

The alignment of porous materials may occur due to changes in associated molecules. Examples of such associated molecules include surfactants that have a portion that adsorbs to the surface of the porous material. Associated molecules may also include molecules which entrain, encircle, or otherwise entrap porous materials. Associated molecules may further include molecules containing functional groups that react with functional groups on the outer surface of the porous materials.

Functional groups of the associated molecules that may undergo conformational changes include, for example, groups from the following classes: diarylethenes, tiphenylmethanes, spiropyrans, spiroxazines, azobenzenes, and furylfulgides. Other functional groups that may undergo conformational changes include those in molecules with signal induced cleavages of bonds (e.g., nitrophenyl-EGTA (NP-EGTA), 1-(4,5-dimethoxy-2-nitrophenyl) EDTA (DMNP-EDTA), etc.) in molecules with signal induced bond forming or transforming reactions, and in molecules with the signal induced creation of products that may induce such reactions, for example, pararosanilines, triarylmethanes, benzophenones, acetophenones, vinylbenzylthymines, vinylphenylcinnamates, anthrones, anthrone-like heterocycles, vinylbenzyluracils, anthraquinone, vinylcoumarins, vinylchalcones, N-acryloylamidopyridinium halides, diarylethenes, benzopyrans, napthopyrans, dithienylethenes, thiazenes, azines, thiamine, uracil, dinitrobenzylpyridines, and/or the substituted derivatives thereof, titanium, platinum, barium, magnesium, silicates, oxides of these and other inorganic materials, metal-organic complexes and frameworks, liquid crystals, and/or ionic liquids.

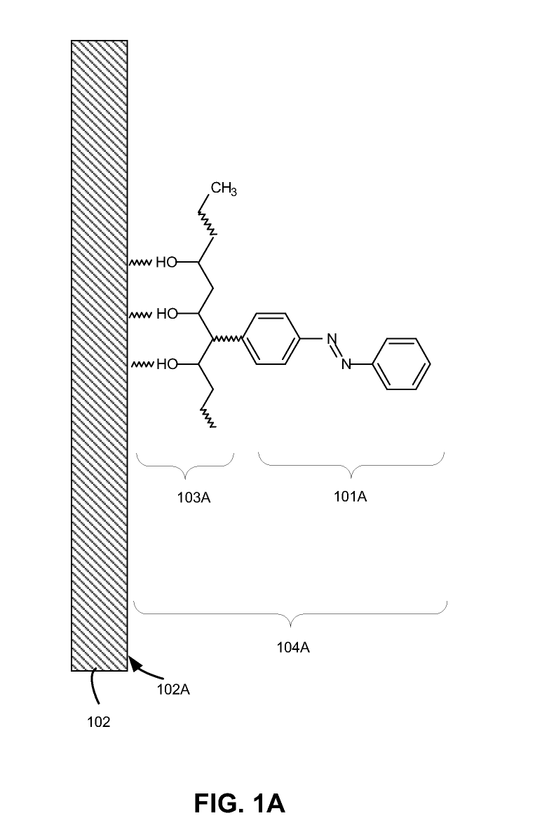

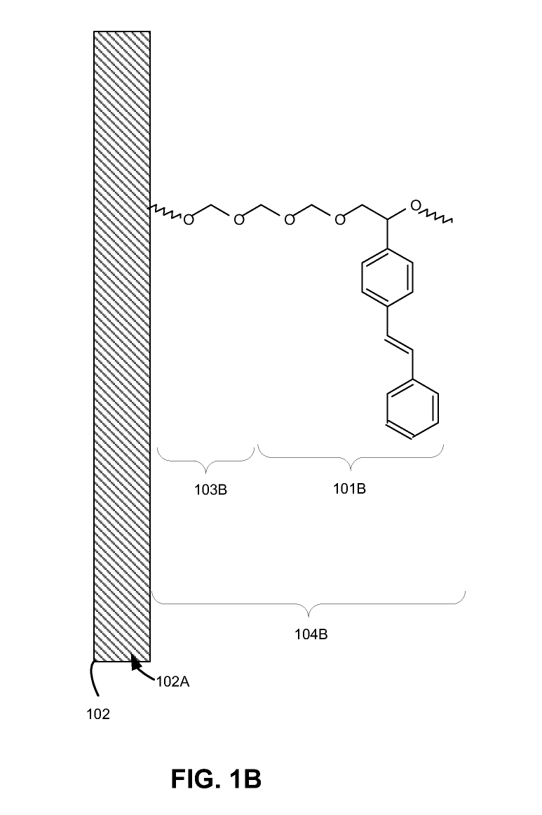

In some embodiments, signal responsive functional groups may be attached to surfaces in order to facilitate and control alignment. Examples of surface materials may include conductive, semiconductor, or insulator substrates, such as metal, glass, silicon dioxide, ceramic, metal organic framework, zeolite, polymer, and/or porous polymer film. Mechanisms of attaching signal responsive functional groups to such surfaces may include, for example, cross-linking, ionic bonding, and Van der waals forces. In some embodiments, the points of attachment may cause conformable groups to be normally perpendicular to the surface or normally parallel. FIG. 1A illustrates an example of a perpendicular attachment that may be present in the various embodiments: a photo-reactive group, azobenzene 101A in its trans configuration with a polyvinyl alcohol chain 103A forms a conformational group 104A which is covalently bonded with hydroxyl groups on a surface 102A of a substrate 102. FIG. 1B illustrates an example of a parallel attachment that may be present in the various embodiments: a photo-reactive group, stilbene 101B having a branched side chain bonded to a polyethylene glycol group forms a conformational group 104B which is perpendicular to a surface 102A of a substrate 102, causing the stilbene molecule to be normally parallel in its trans configuration.

Another surface attachment mechanism may include the formation of a Langmuir-Blodgett film to coat a microporous membrane with surfactants. The microporous membrane may be composed of cellulose acetate, polyamide, polyethersulfone, polyacrylonitrile, silicon dioxide, semi-conductors, zeolites, ceramics, block co-polymers, and/or other materials.

In addition to materials with functional groups that are directly responsive to signal inputs, other materials may be beneficially added to enhance or modify the desired alignment effects. Such enhancing materials may include, for example, moieties that confer solubility to organic molecules, nanomaterials, porous materials, and/or polymers. Enhancing materials may also include moieties with groups capable of ionic bonding (e.g., salts of organic acids) which are modifiable by the action of signal responsive materials. Enhancing materials may also include those with groups that provide pH or other buffering effects, such as those that contain hydroxyl groups or carbonic acid groups, (e.g., carbonates or other inorganic buffers, polymers, non-polymer molecules, dendrimers, etc.). Enhancing materials may also include metal oxides, mixed inorganic frameworks, and metal-organic materials.

Additional useful additives that may be used in the various embodiments may include sensitizers (e.g., free radical generators or substances that change or expand the range of radiation wavelengths or other signals that may be used), oxygen and/or other bleaches (e.g., NaHOCl, KCn, NaHSO₃, Zn and HCl, KOH, acidified thiourea, etc.), and/or photoinitiators. In some embodiments, addition of buffers for changes in pH may be useful in order to maintain compatibility with other system components or solutes. In other embodiments, addition of anti-oxidants may be desired. In some embodiments, addition of dispersants may be desired to prevent aggregation of the porous materials. In some embodiments, the suspension may require removal and exclusion of oxygen and/or other oxidizers.

The changes to the molecules associated with the porous materials may include changes in the conformation of the molecules and/or functional groups within the molecules, in response to a signal. The conformational changes may include, for example, transformation from cis to trans configurations or vice versa, opening or closing of aromatic rings, breaking or forming of bonds between portions of the molecule, breaking or forming of bonds between nearby molecules or between them and secondary substances within the suspension, and/or changes in orientation in response to a director field.

Signal input that may cause changes in conformation include, for example, ultraviolet light, visible light, and/or other electromagnetic radiation outside of the ultraviolet and visible spectra (e.g., infrared or microwave radiation), electrical current, change in magnetic field, sonic or other mechanical energy, introduction or removal of a secondary substance, and/or introduction of shear forces due to flow.

In the various embodiments, the aligned porous materials are also fixed in their positions after alignment. Methods of fixation may include, for example, exposing the suspension to a second signal that causes cross-linking, polymerization, or other reactions between the porous materials that leads to a rigid or semi-rigid structure. Methods of fixation may also include cross-linking, polymerization, or other reactions between the molecules of the porous material and other components of the suspension. Methods of fixation may also include various reactions between other components of the suspension with one another, and/or changes in temperature or other conditions leading to the formation of a solid phase.

In various embodiment processes of forming selective membranes, porous materials may be entrained in suspension by molecules containing signal responsive functional groups discussed above. The suspension may also contain materials that are polymerizable or otherwise signal responsive with respect to fixation through transition to a solid medium. In the various embodiments, the suspension may be exposed to a first signal that causes the alignment of the entrained porous materials, and then exposed to a second signal that causes the fixation of this alignment. The suspension may form a liquid crystal in some embodiments. In some embodiments, the signal responsive molecules for alignment may include photo responsive functional groups that align with polarized light. In other embodiments, signal responsive molecules may include functional groups that are alignable by electric or magnetic fields. In other embodiments, signal responsive molecules may include functional groups that facilitate alignment due to shear forces from flow, such as capillary-induced flow.

In an embodiment process of forming selective membranes, porous structures (e.g., carbon nanotubes (CNTs)) may be fabricated, and those having a small inner diameter (e.g., less than 10 Å, such as less than 8 Å (e.g., 4-7 Å) may be selected for use. The selected carbon nanotubes may be mixed with a suspension containing a surfactant. Surfactant molecules may have hydrophobic portions that adsorb to, encircle, or otherwise entrain, the external surface of the CNTs. The surfactant molecules may further contain, or be modified to contain, photo-responsive functional groups that cause conformational changes to the surfactants upon exposure to ultraviolet light. In this manner, exposure to ultraviolet light causes alignment of the surfactant molecules, thereby causing alignment of the CNTs. Examples of modified or unmodified surfactants that may be used include sodium dodecyl sulfate (SDS), cetyltrimethylammonium bromide (CTAB), dodecyl(trimethyl)azanium bromide (DTAB), sodium lauryl ether sulfate (SLES), and 4,4′-diaminodiphenyl sulfone (DDS), and other substances with surfactant characteristics. Surfactants may also be induced to form hexagonal or cylindrical phase liquid crystals, thereby facilitating porous material alignment.

The suspension may also contain molecules which that undergo polymerization reactions upon exposure to a second wavelength of ultraviolet light. In this manner, the suspension may be transformed from a fluid to a solid phase composition, thereby fixing the aligned CNTs in their aligned positions.

In some examples of this embodiment, the molecules that allow for fixation of the aligned CNTs may be hydroxyethylmethacrylate molecules in the presence of a photoinitiator (e.g., Darocure TPO). Upon exposure to ultraviolet light at a wavelength of around 365 nm, hydroxyethylemthacrylate may polymerize to form poly(hydroxyethylmethacrylate), creating a stable polymer film containing the aligned CNTs. In other examples of this embodiment, fixation of the aligned CNTs may be accomplished using one or more of a variety of ultraviolet-curable materials, examples of which may contain one or more of acrylates, amines, amides, and imidizoles. Other example ultraviolet-curable materials that may be used to fix the aligned CNTs include diphenyliodonium hexafluorophosphate, triphenylsulfonium hexafluorophosphate, diaryl iodonium salts, triaryl sulfonium salts. In alternative embodiments, the fixation of the aligned nanotubes may be achieved by allowing an initially hot, liquid suspension to cool, thereby becoming solid.

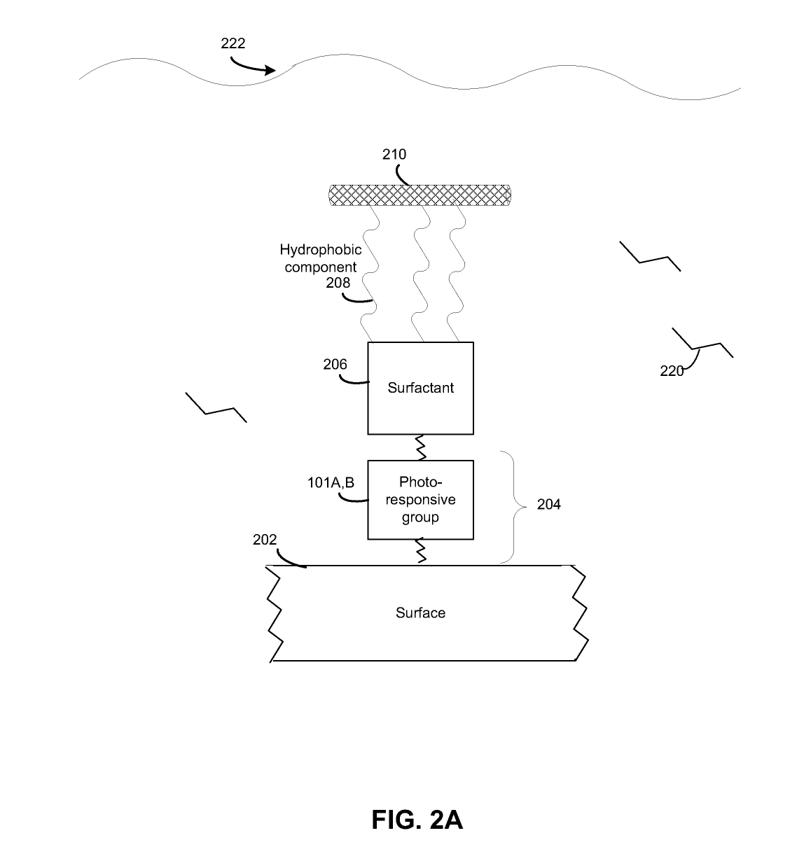

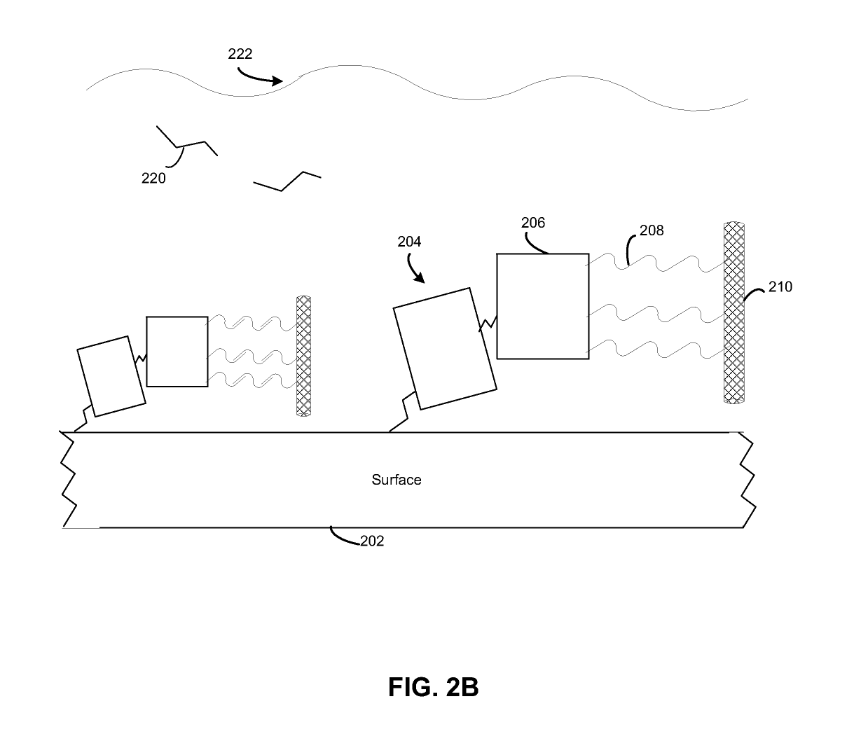

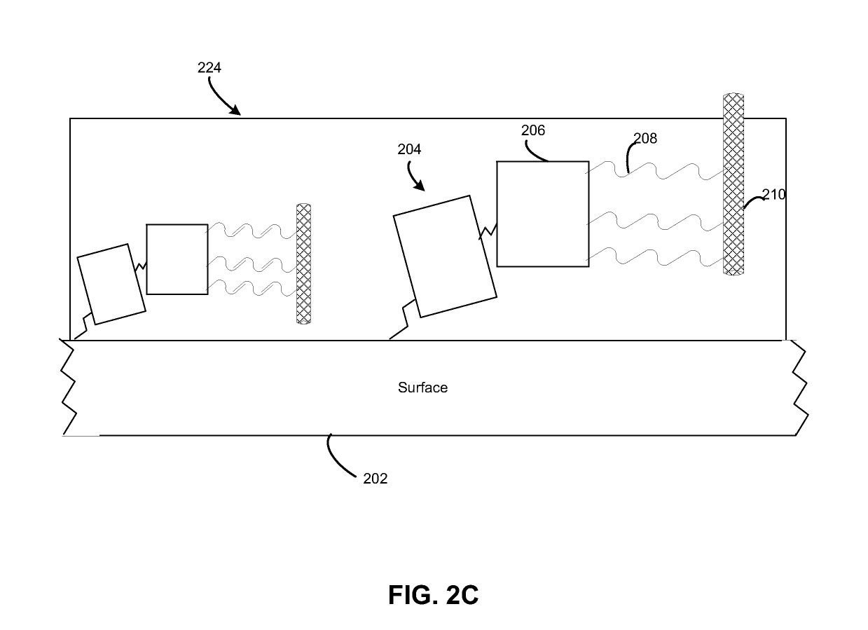

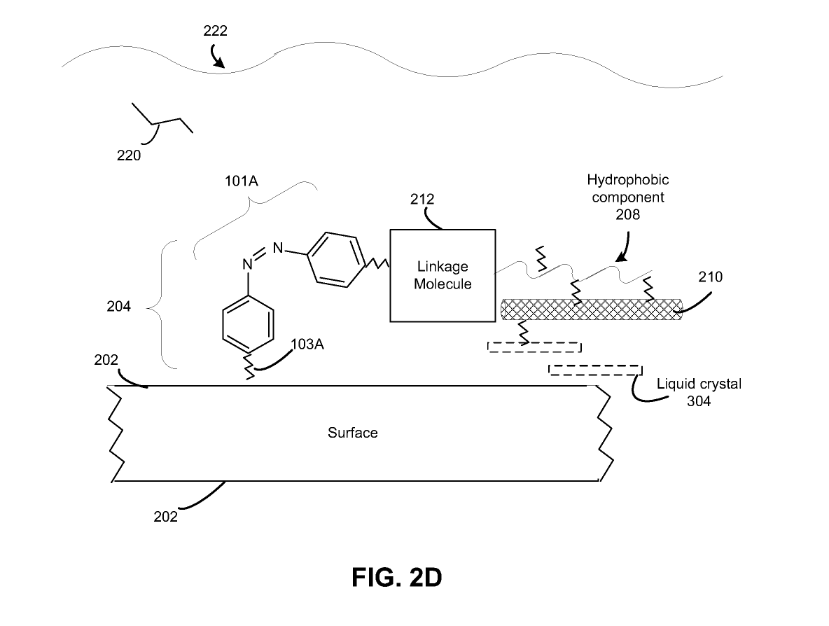

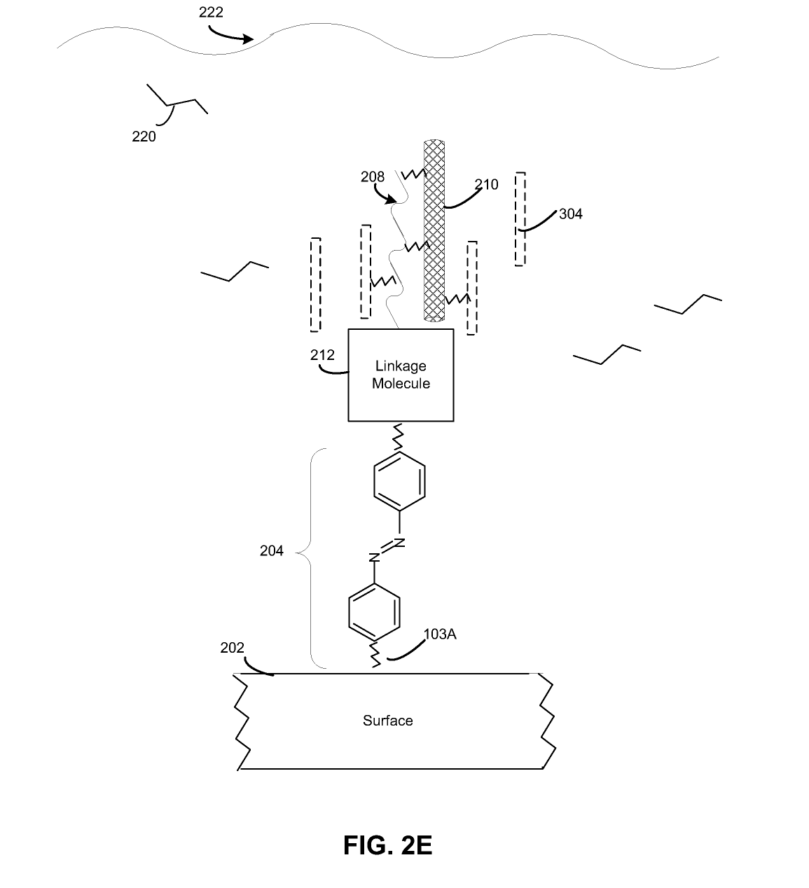

In an embodiment process of forming a selective membrane, surfactant molecules 206 in an aqueous suspension 222, shown in FIG. 2A, may be covalently bonded to a surface 202 (e.g., substrate surface) by photo-responsive conformational groups 204, such as azobenzene 101A or stilbene 101B containing groups. The surfactant molecules 206 may also be attached to the conformational groups 204 by covalent bonding or Van der Waals forces. The surfactant molecules 206 contain long chain hydrophobic groups 208. Porous structures, such as nanotubes 210, may be adsorbed otherwise attached (e.g., covalently bonded, attached by Van der Waals forces, ensnared by groups 208 or by optional liquid crystals, etc.) to the long chain hydrophobic groups 208 of the surfactant molecules 206. In one example, exposure to ultraviolet light may cause alignment of the nanotubes parallel to the surface, while exposure to visible light may cause perpendicular alignment, by change in conformation of the photo-responsive surfactant groups, as shown in FIG. 2B. In another example, exposure to visible light may cause alignment of the nanotubes perpendicular to the surface, while exposure to visible light may cause parallel alignment. Cycling between parallel and perpendicular states may enhance overall alignment. Optionally, a suspension 222 solvent containing these molecules 204, 206/208 and nanotubes 210 may also contain other molecules, such as monomers 220, which will be used to form a polymer matrix film in a subsequent step.

FIG. 2B shows a change in conformation of the photo-responsive group 204 from FIG. 2A. In this example, upon exposure to a signal (e.g., ultraviolet or visible light), the photo-responsive group 204 may be changed, such as based on bonds created or formed as a result of the signal. As shown in this example, multiple molecules containing the photo-responsive group 204 in suspension may interact with the surface 202 and nanotubes 210.

FIG. 2C illustrates a polymer layer 224 in which the aligned nanotubes 210 may be fixed by exposure to a second signal input (e.g., a second wavelength of ultraviolet light). The polymer layer may be formed by crosslinking or polymerization of additional reactants, such as monomers 220, present in suspension with the linkage molecules (e.g., 204, 206/208, etc.) and optional liquid crystals, in response to the second signal input.

FIGS. 2D and 2E illustrate an exemplary embodiment of the method of FIGS. 2A and 2B. As shown in FIG. 2D, a photo-reactive group that that may be used is azobenzene 101A. In this embodiment, linkage molecules 212 (e.g., surfactant 206/208 or other linking molecules or compounds) in suspension 222 may be covalently bonded to a surface 202 by a conformational group 204 containing photo-responsive (e.g., photo-reactive) azobenzene groups 101A and linker 103A. Molecules 212 may have hydrophobic components 208 (e.g., long chain polyvinylalcohol (PVA)) to which nanotubes 210 may be adsorbed in the suspension 222. In this embodiment, the suspension may optionally include a nematic liquid crystal 304, such as aqueous dodecyltri-methylammonium bromide, which may also or preferentially adsorb or entrain the nanotubes. The liquid crystal may be in a hexagonal, cylindrical, or other anisotropic phase. The hydrophobic components/long chains of the linkage molecules 212 in the suspension may interact with the liquid crystal molecules 304.

Exposure to visible light may cause a change in conformation of the azobenzene groups by changing from a cis configuration, shown in FIG. 2D to the trans configuration, shown in FIG. 2E. Such change in azobenzene conformation may cause a consequent change in orientation of the interacting portion of the groups 208 (e.g., PVA chains) of molecules 212, which may in turn induce the liquid crystal 304 and nanotubes 210 to change their alignment to have their long axes perpendicular to the surface 202 (or parallel, depending on the structure of the specific linkage molecule 212 to which azobenzene is attached). For example, azobenzene in the cis configuration of FIG. 2D bends about 90 degrees to become trans azobenzene shown in FIG. 2E, which causes rotation of linkage molecules 212, hydrophobic groups 208, and nanotubes 210. Further, exposure to ultraviolet light may cause a change in conformation of the azobenzene groups by changing back from trans to cis configurations. The change in azobenzene conformation may again cause a consequent change in the interacting portion of the molecules (e.g., PVA chains), which may in turn induce the liquid crystal and nanotubes to revert back to an original parallel alignment to the surface 202 (or perpendicular, again depending on the linkage molecule 212 to which azobenzene is attached). Cycling between parallel and perpendicular states may enhance overall alignment. In an example, the alignment effects may be enhanced by the use of an electric or magnetic field, acting upon the liquid crystal.

The suspension 222 may additionally contain reactants 220 that may form crosslinks or polymerize upon exposure to a second wavelength of light or other signal, thereby causing fixation of the aligned nanotubes 210 in the polymer layer 224, as described above. Example reactants that may be used to form the polymer layer which is used to fix the aligned nanotubes include monomer hydroxyethyl methacrylate, cross-linker poly(ethylene glycol)-400 dimethacrylate, and photoinitiator Darocure TPO. Further, the alignment effects may be enhanced by the use of an electric or magnetic field, acting upon the liquid crystal.

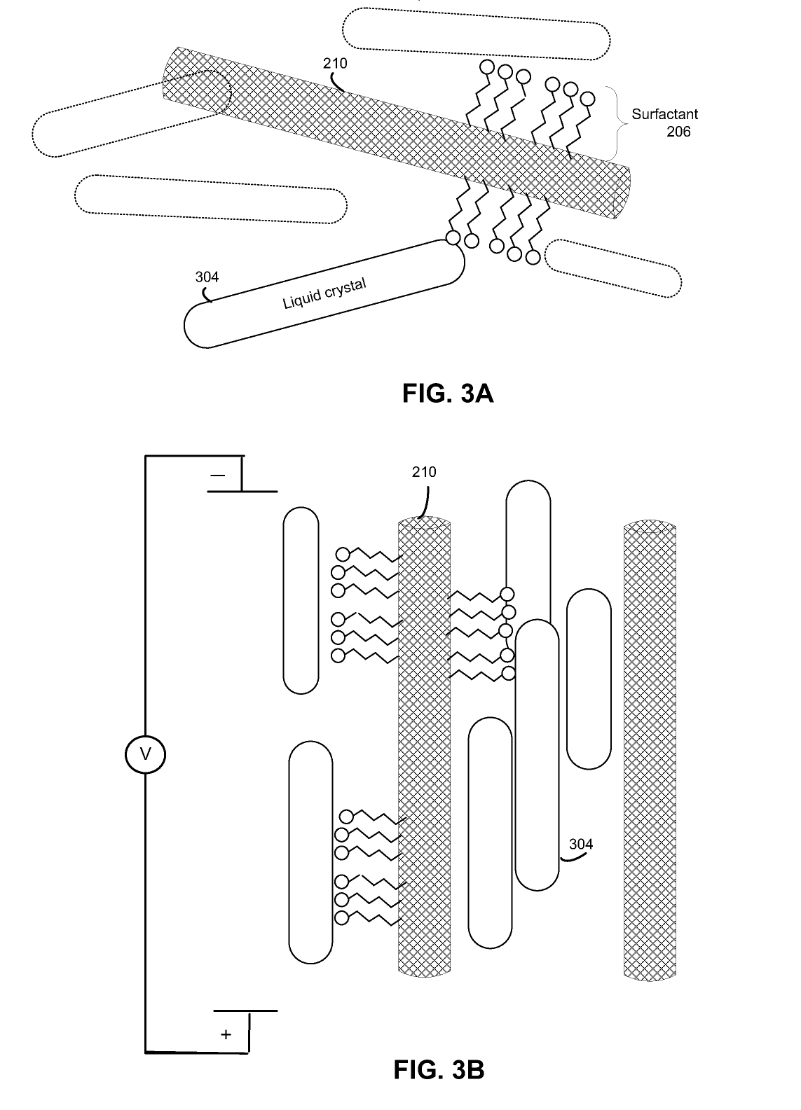

In another embodiment illustrated in FIG. 3A, randomly oriented nanotubes 210 in suspension are affixed to surfactant molecules 206, which may include functional groups that interact with randomly oriented liquid crystal molecules 304. Alignment may occur by subjecting the suspension to an electric field. Specifically, as illustrated in FIG. 3B, exposure to the electric field may cause the liquid crystal molecules 304 to align perpendicular to a surface, thereby causing the nanotubes 210 to align perpendicular to the surface. The suspension may then be exposed to ultraviolet or visible light to cause other molecules (e.g., monomers) within the suspension to undergo cross linking and/or polymerization reactions, thereby fixing the aligned position of the nanotubes/liquid crystal matrix in a polymer layer.

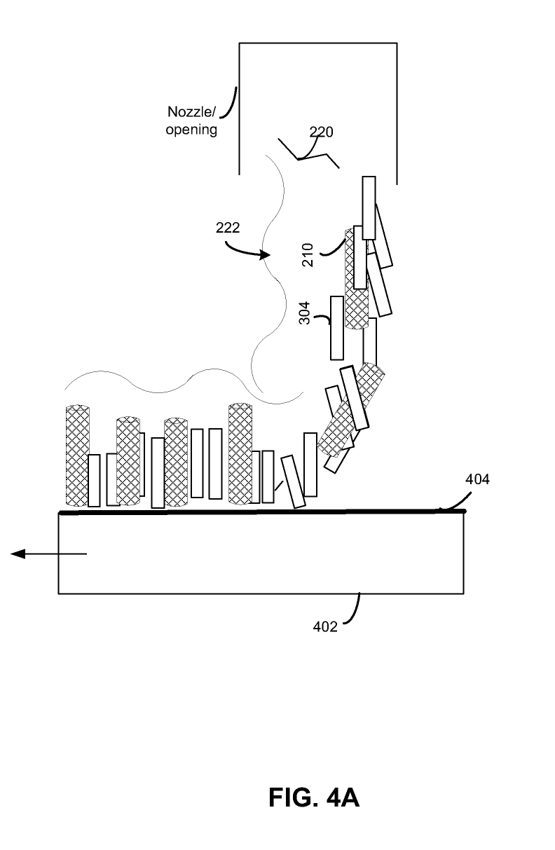

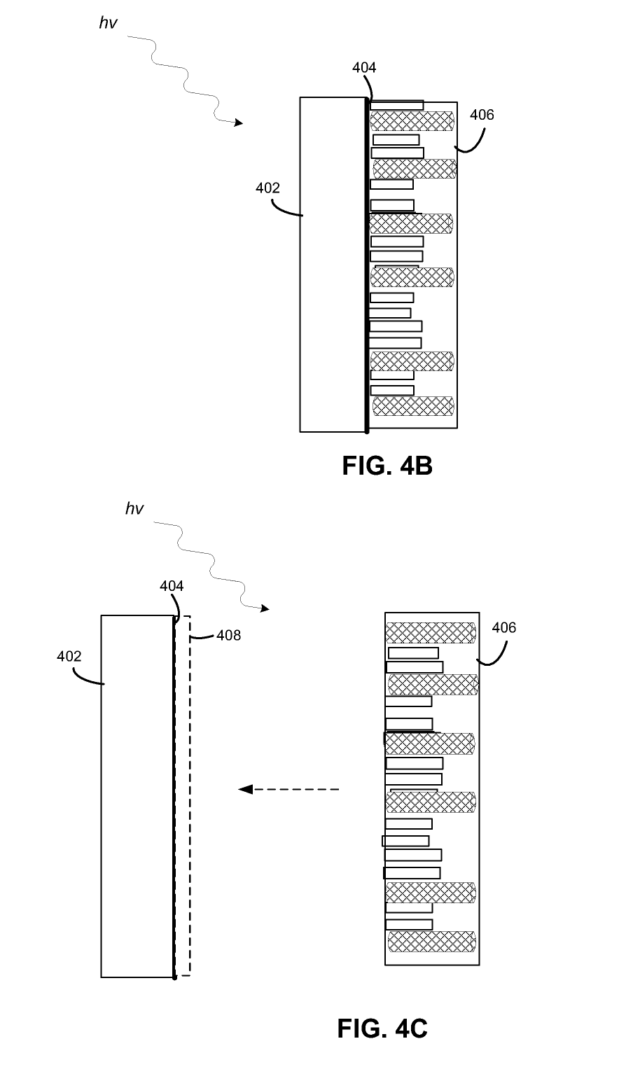

In another embodiment, the nanotubes are affixed to surfactant molecules and/or entrained within liquid crystal molecules in the suspension. The suspension may then be exposed to a surface with molecules that cause ordering of the crystals. Optionally when, both surfactant and liquid crystal molecules are present, surfactant molecules may include functional groups that interact with the liquid crystal molecules. Examples of the molecules that may be applied to the surface to cause ordering include, but are not limited to, surfactants, lecithins, and polyimides. Examples of the surface containing which such molecules include, but are not limited to, membranes, smooth non-porous surfaces (e.g., belts in manufacturing processes), and wet and dry laid papers. In one example illustrated in FIG. 4A, carbon nanotubes 210 may be entrained by liquid crystals 304 in the monomer 220 containing suspension 222 and coated on a belt 402 in a continuous manufacturing process. The surface of the belt 402 may be smooth and largely non-porous, and may have been previously modified to be coated with molecules 404 to cause ordering of the liquid crystals 304 in an orientation perpendicular to the belt surface 402, as shown in FIG. 4A. An example method of creating the coating of liquid crystals with carbon nanotubes may be by formation of a Langmuir-Blodgett film 404 on the belt 402.

Once ordering of the liquid crystals 304 has occurred, then as shown in FIG. 4B a first wavelength of ultraviolet light may be used to cause polymerization of monomers 220 within the suspension 222, thereby fixing the liquid crystals 304 and the carbon nanotubes 210 in their aligned position perpendicular to the belt 402 surface 402A. In this manner, a thin, flexible polymer film 406 containing the liquid crystals 304 and carbon nanotubes 210 aligned perpendicular to the surface 402 may be formed. In FIG. 4C, a second wavelength of light may be used to cause the film 406 to separate from the belt surface 402. Such second wavelength may cause the molecular layer 404 to dissolve. Optionally, an additional photo-responsive release layer 408 (e.g., a photoresist or photosensitive polymer which uncrosslinks and is dissolved or another layer which can be selectively etched away) may exist between the molecular layer 404 and the polymer film 406 to enable separation (e.g., by etching). The free standing film 406 may then be layered with other materials or used alone as a semi-permeable selective membrane.

In the various embodiments, post treatment of the film 406 at the top and/or bottom surface of the film may be employed to open the ends of the carbon nanotubes 210 exposed in or above film surfaces. Methods that may be employed may include, for example, chemical etching, plasma etching, abrasive removal of material, and oxidation, among others.

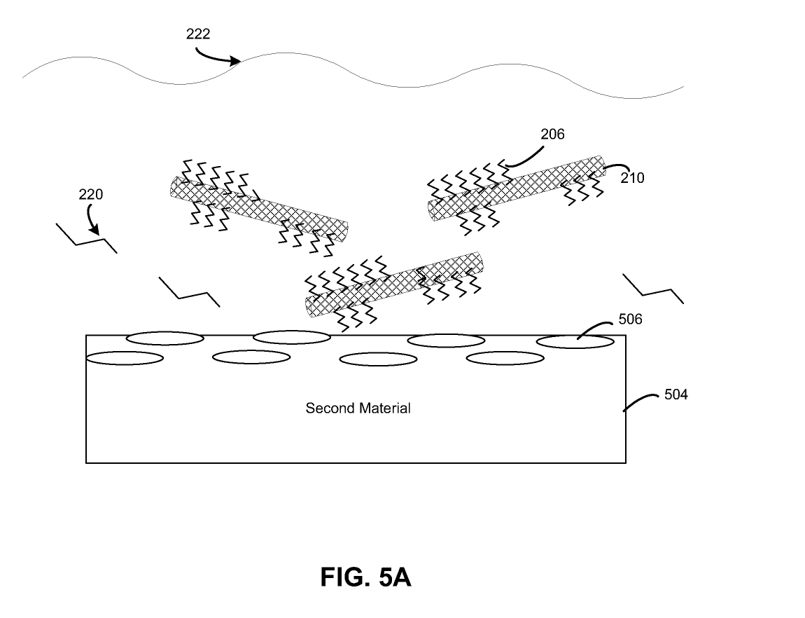

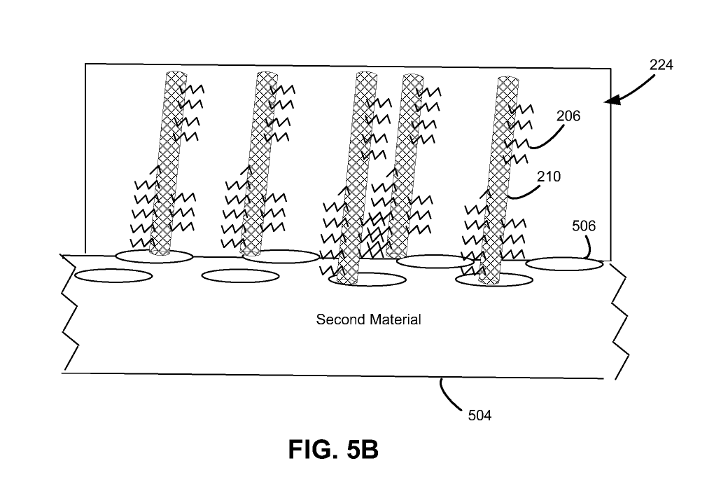

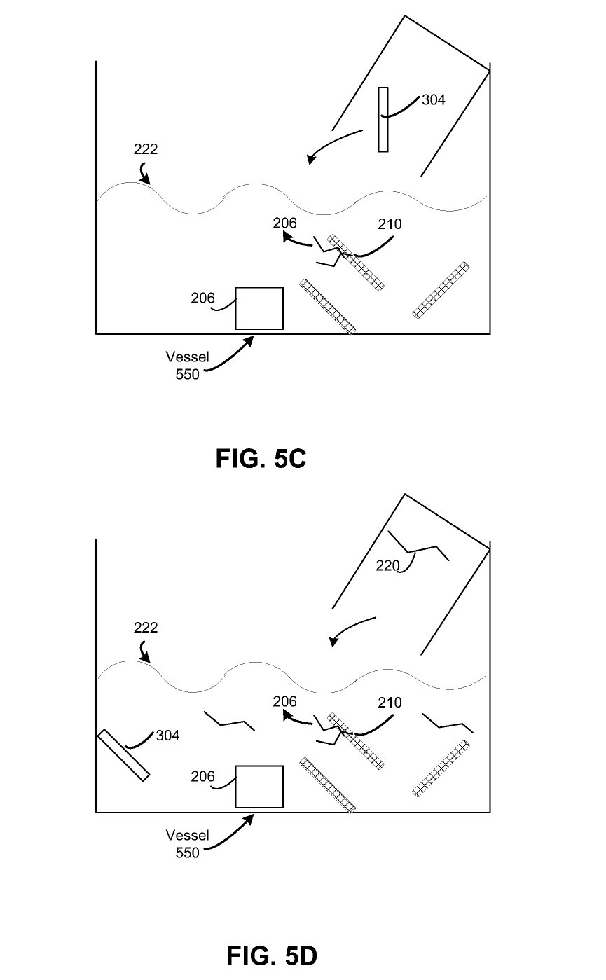

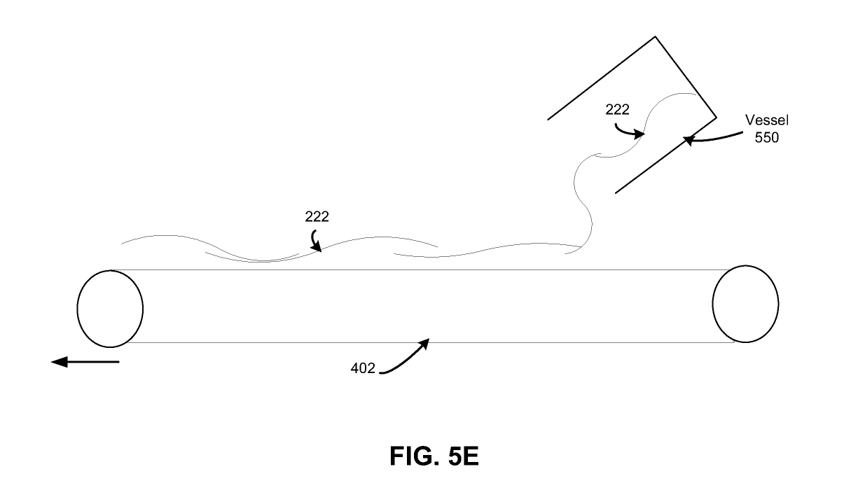

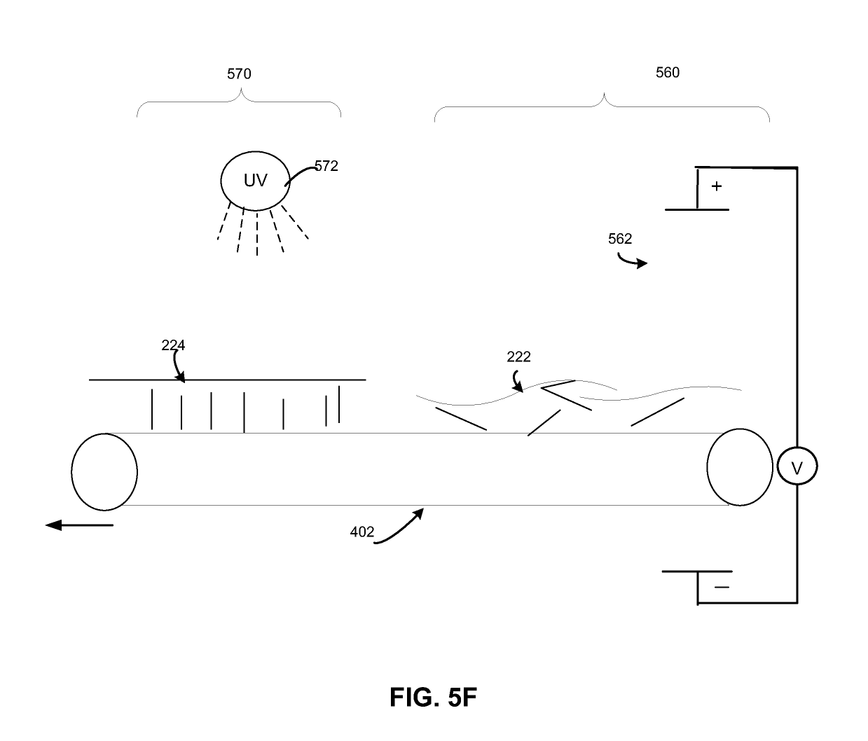

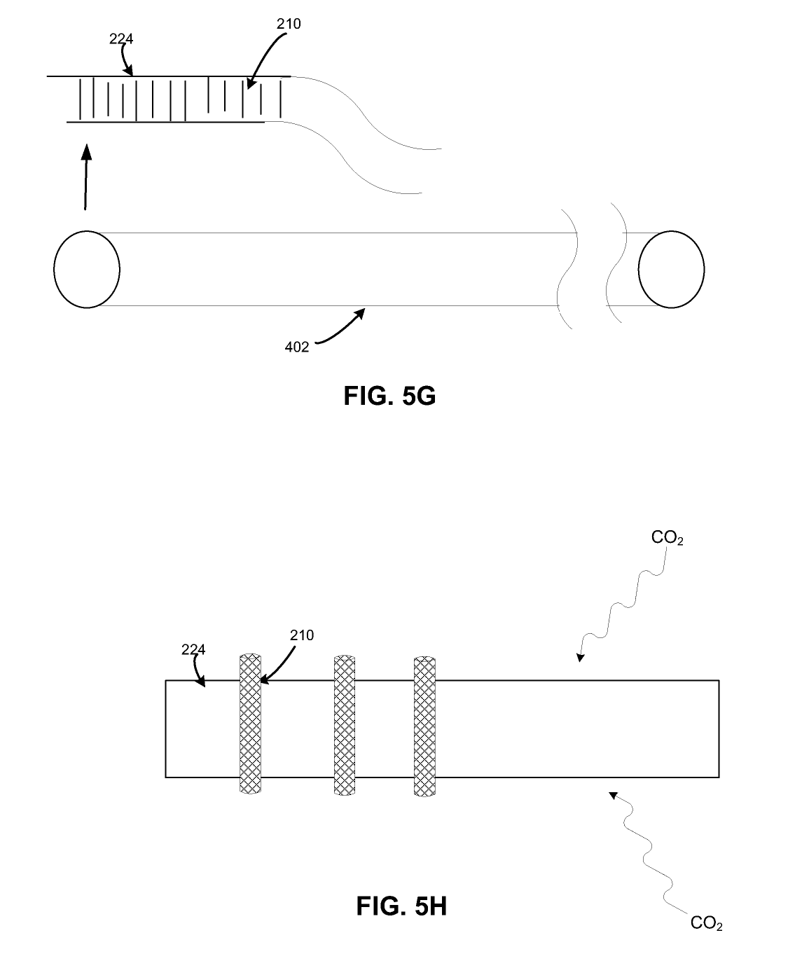

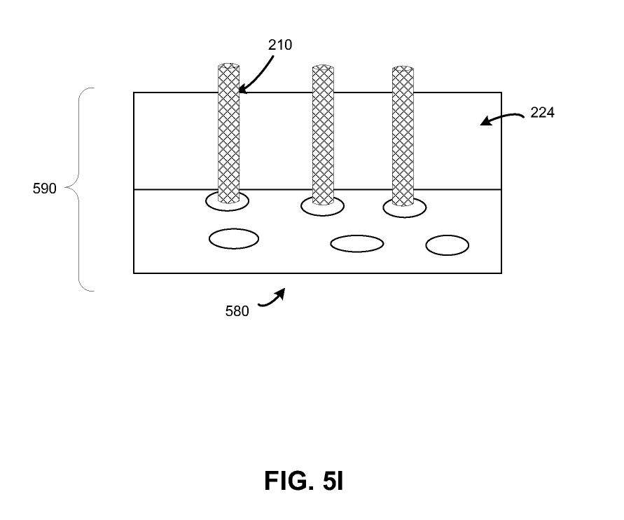

In another embodiment process of forming a selective membrane, a suspension shown in FIG. 5A may contain surfactant 206 dispersed carbon nanotubes 210 and ultraviolet light-polymerizable monomers 222. A second material 504 that is porous and hydrophilic may then be placed in contact with the suspension 222, such as by placing material 504 into, under or over the suspension. An example of the second material 504 may be a microporous hydrophilic membrane sheet made of polyethylene glycol diacrylate. In an embodiment, capillary forces may cause the suspension to flow into the pores 506 of the second material 504, thereby inducing the alignment of the carbon nanotubes 210 within the pores due to shear forces within the suspension, as shown in FIG. 5B. Following alignment, ultraviolet light is used to cause polymerization within the aqueous suspension, thereby fixing the aligned carbon nanotubes within the pores by the polymer film 224. In some examples, post processing may be performed to open up either or both ends of carbon nanotubes. In an alternate embodiment, the porous hydrophilic material 504 may be exposed to the surface of a tank containing the suspension. In another alternative embodiment, the suspension may be applied to the surface 502 with the second material 504 placed on top of the suspension.

In an example shown in FIG. 5C, steps involved in forming a selective membrane according to various embodiments may be performed in continuous process as follows. A suspension 222 containing approximately 1 mg/mL of single-walled carbon nanotubes 210 having inner diameters of around 5 Å, and dispersed in a concentration of approximately 0.5% SDS surfactant 206, may be mixed with Merck liquid crystal 304 mixture E7 in a vessel 550. The resulting suspension may be agitated to mix the carbon nanotubes within the liquid crystal structure, and may be allowed to stabilize to ensure formation of a nematic liquid crystal phase with entrained carbon nanotubes. As shown in FIG. 5D, polymerizable reactants 220 may be added to the resulting suspension, examples of which may include a monomer (e.g., hydroxyethyl methacrylate), a crosslinker (e.g., poly(ethylene glycol-400 dimethacrylate)), and a photoinitiator (e.g., Darocure TPO). This suspension may be introduced with minimal shear, so as not to disturb the liquid crystal order, to a smooth conveyor belt 402, as shown in FIG. 5E. In an example, the conveyor belt may be approximately 40 inches in width, and the suspension may form a layer approximately 25 μm thick.

Next, as shown in FIG. 5F, the belt 402 may move this suspension 222 in a continuous process into a region 560 were an electric field from electric field source 562 (e.g., electrode plates, etc.) orients the liquid crystals 304 such that they are perpendicular to the belt surface, which in turn similarly orients the carbon nanotubes 210. Then, in downstream region 570, ultraviolet light from an ultraviolet lamp 572 may be applied to the aligned liquid crystals 304 and carbon nanotubes 210, which may cause polymerization of the hydroxyethyl methacrylate monomers 220 to form a poly(hydroxyethylmethacrylate) polymer film 224 containing aligned carbon nanotubes 210. In this manner, the aligned liquid crystals 304 and carbon nanotubes 210 may be fixed in a stable, solid polymer film 224. Film 224 may be a non-porous film to form a non-porous skin around the nanotubes 210 (e.g., as described in U.S. Pat. No. 8,196,756, incorporated herein by reference in its entirety) or it may be a porous film that acts as a secondary filter.

Next, the solid film 224 may be removed from the belt 402 as shown in FIG. 5G. The film 224 is then treated with a carbon dioxide oxidation process or any suitable removal process on each side in order to remove excess film 224 material covering the ends of carbon nanotubes 210 such that the ends of the carbon nanotubes 210 are exposed on each side, as shown in FIG. 5H. The treated solid film 224 may be then placed on a highly porous supporting material 580 and bonded through calendaring or another suitable bonding process as shown in FIG. 5I. This bonded material may be used as a selective membrane 590 for gas or liquid separations.

In alternate embodiments, various parameters may be changed, including the type and/or concentration of porous materials, the type and/or concentration of surfactant used for porous material dispersal, the type of liquid crystal, the type of fixation additive, the method of signaling used to fix the liquid crystal and porous materials. In some embodiments, the substrate for deposition of suspension may be a plate, porous membrane, or other type of substrate other than a belt. In some embodiments, the method of opening the ends of the porous material may be chemical, mechanical, laser, plasma, or other mechanism that does not otherwise damage the film in-between the porous materials.

In one or more embodiments, the thickness of the film 224 may be between 0.5 and 1 μm thick, in order to facilitate the use of shorter length porous materials. In one or more embodiments, the surface upon which the porous material suspension is applied may be smooth and non-porous, but designed to allow for post-processing to create pores after porous material alignment and fixation. Examples of such post-processing pore creation may include chemical, plasma, or laser etching, or light induced cleavage of bonds between portions of the surface.

In alternate embodiments, various combinations of alignment methods may be employed. For example, electric fields and light signals (e.g., ultraviolet or visible light) may be used together to increase effectiveness and reduce energy requirements.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the steps as a sequential process, many of the steps can be performed in parallel or concurrently.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method of forming a selective porous membrane from at least one anisotropic porous material, comprising:
aligning the at least one anisotropic porous material in an aligned position by introducing a first signal input; and
fixing the at least one anisotropic porous material in the aligned position by introducing a second signal input.

2. The method of claim 1, wherein the at least one anisotropic porous material comprises one or more of carbon nanotubes, aquaporin, and synthetic aquaporin pore structures.

3. The method of claim 2, wherein the first signal input is selected from the group of:
ultraviolet light, visible light, infrared light, microwave radiation, and electrical current.

4. The method of claim 3, wherein the at least one anisotropic porous material is associated with at least one photo-responsive functional group, wherein aligning the at least one anisotropic porous material occurs as a result of a change in conformation of the at least one photo-responsive functional group.

5. The method of claim 4, wherein the at least one photo-responsive functional group is part of a molecule selected from the group of:
diarylethenes, tiphenylmethanes, spiropyrans, spiroxazines, azobenzenes, furylfulgides and photosensitive chelators comprising nitrophenyl-EGTA (NP-EGTA) and 1-(4,5-dimethoxy-2-nitrophenyl) EDTA (DMNP-EDTA).

6. The method of claim 1, wherein aligning the at least one anisotropic porous material occurs in the presence of an energy field, wherein the energy field induces or assists in the alignment.

7. The method of claim 6, wherein the energy field comprises an electric or a magnetic field.

8. The method of claim 1, wherein introducing the first signal input comprises introducing mechanical force.

9. The method of claim 8, wherein the mechanical force comprises a shear force induced by fluid flow.

10. (canceled)

11. The method of claim 1, wherein introducing the first signal input comprises introducing a surface, wherein characteristics of the surface induce alignment of the at least one anisotropic porous material.

12. The method of claim 11, wherein the characteristics of the surface that induce alignment are caused by a pattern of molecules protruding from the surface.

13. The method of claim 12, wherein the molecules protruding from the surface comprise one or more molecules selected from the group of:
surfactants, lecithins, polyimides, and polyvinyl alcohol.

14-15. (canceled)

16. The method of claim 1, wherein the at least one anisotropic porous material is associated with at least one surfactant, wherein the at least one surfactant facilitates alignment of the at least one anisotropic porous material in response to the first signal input.

17. The method of claim 1, wherein the at least one anisotropic porous material is associated with at least one liquid crystal material, wherein the at least one liquid crystal material facilitates alignment of the at least one anisotropic porous material in response to the first signal input.

18. The method of claim 1, wherein:
the at least one anisotropic porous material is in suspension with at least one other chemical species;
the second signal input comprises electromagnetic radiation; and
fixing the at least one anisotropic material occurs by at least one of polymerization and cross-linking of the at least one other chemical species induced by the second signal input to form a polymer film containing aligned, embedded anisotropic porous material.

19. (canceled)

20. The method of claim 1, wherein introducing the second signal input comprises changing an environment characteristic of the at least one anisotropic porous material.

21. The method of claim 20, wherein changing the environment characteristic comprises reducing the temperature of the environment of the at least one anisotropic porous material.

22. The method of claim 1, further comprising employing a secondary treatment to open the ends of the fixed at least one anisotropic porous material.

23. (canceled)

24. The method of claim 1, wherein:
the at least one anisotropic porous material comprises a carbon nanotube that interacts with a linkage molecule, wherein the linkage molecule is attached to a photo-responsive molecule bound to a surface; and
introducing the first signal input comprises exposing the carbon nanotube, linkage molecule and photo-responsive molecule to radiation to rotate the photo-responsive molecule and align the carbon nanotube perpendicular to the surface.

25. The method of claim 24, wherein the linkage molecule comprises a surfactant.

26-28. (canceled)
